(19) United States
(12) Patent Application Publication
(10) Pub. No.: US 2005/0051346 A1
(43) Pub. Date: Mar. 10, 2005

(54) Reed weed extractor

(76) Inventor: Edward J. Reed, Helena, MT (US)

Correspondence Address: MICHAEL S. KAKUK;KAKUK LAW OFFICES, P.C., 40 W. 14TH ST., SUITE 2D, HELENA, MT, 59601, US

(21) Appl. No.: 10/935,141

(22) Filed: Sep. 7, 2004

Related U.S. Application Data
(60) Provisional application No. 60/500,802, filed on Sep. 4, 2003.

(51) Int. Cl. A01B 1/00

(52) U.S. Cl. 172/371

(57) ABSTRACT

A weed extractor utilizing a cutting head attached to a shaft with a method for removing extracted weeds from the cutting head. Such extractor designed for use with a standard portable hand-held drill.

### CROSS REFERENCE To RELATED APPLICATIONS

This application claims the benefit of a Provisional Patent Application, Application No. 60/5000,802, filing date of Sep. 4, 2003.

### STATEMENT REGARDING FEDERALLY SPONSORED RESEARCH OR DEVELOPMENT

This application is not based on any federally sponsored research and development.

### BACKGROUND OF THE INVENTION

There is a need for a practical, efficient, low-cost, and easy to use, weed extractor to remove common lawn weeds. Most of the devices currently available do not remove enough of the weed to reduce the likelihood of the weed from re-growing or require tiresome and physically demanding tasks, sometimes including actually digging the weed out by hand. The Reed Weed Extractor uses a simple but effective rotating cutting device that can be attached to a standard rotary portable drill. There are patents that also describe such drill and rotating cutting device combinations. For example, Aman, U.S. Pat. No. 3,554,293, issued Jan. 12, 1971, and now in the public domain, described using a portable electric drill to power a rotating cutting device used to extract weeds. However, the Aman device, by its very design, could not penetrate deeply enough into the soil to better ensure that the root crown was fully removed. Without removing the root crown, many weeds, such as dandelions for example, will quickly return.

Likewise, the Howard weed extractor, U.S. Pat. No. 5,810,093, issued Sep. 22, 1998, also describes a drill powered circular cutting device one purpose of which is to extract weeds. The Howard device could be used to sufficient depth to potentially remove a weed's root crown but the Howard curved blade design is inferior to the present invention in that the Howard blade has only one cutting edge, can only be operated in one direction, and is difficult to clean and exposes the user to the potentially very sharp cutting edge during cleaning.

### BRIEF SUMMARY OF THE INVENTION

The present invention solves the above described problems in straightforward manner through the use of:
A cutting head comprised of at least two blades with a plurality of teeth on each blade;
A shaft attached to the cutting head. One end of such shaft being able to be placed into a standard electric drill chuck and said shaft being of an appropriate length to enable the weed extractor to remove the root crown and foliage of the weed and to allow for efficient, comfortable, and safe operation of the extractor; and

A weed ejector attached to the shaft and designed to allow the ejector, normally located off of the cutting head, to be pushed over the cutting head thereby removing an extracted weed.

All such components being constructed of such material to allow the weed extractor to function properly and are individually configured and correlated with respect to each other to provide a device used for extracting a weed from the ground in the following manner:
the non-cutting head end of the shaft is attached to the drill chuck of a standard electric drill;
the cutting head is placed directly on top of and contacting the center of the selected weed;
the drill is activated thereby rotating the cutting head while the operator uses a downward pressure sinking the cutting head into center of the weed, and weed root, to a sufficient depth to allow the cutting head to sever the weed from any remaining roots and wrap the severed weed and weed root crown around the cutting head and shaft;
the cutting head is then removed from the ground either before or after stopping the rotation of the drill;
the drill rotation is stopped and the operator slides the weed ejector over the cutting head thereby quickly and effectively removing the weed material from the cutting head and thereby preparing the cutting head for removal of the next selected weed; and.
The weed ejector is then returned to its original position off of the cutting head either manually or through some other manner

### BRIEF DESCRIPTION OF THE SEVERAL VIEWS OF THE DRAWINGS

FIG. 1. Showing the two views of the cutting head.

FIG. 2. Showing the location of the two blades on the cutting head.

FIG. 3. Showing the shaft.

FIG. 4. Showing two views of the weed ejector.

FIG. 5. Showing two views of the weed ejector attached to the shaft.

FIG. 6. Showing the travel of the weed ejector along the shaft.

FIG. 7. Showing the handle and its attachment to the ejector.

FIG. 8. Showing the ejector spring and its location on the shaft.

FIG. 9. Showing how the numerous parts are correlated and assembled.

### DETAILED DESCRIPTION OF THE INVENTION

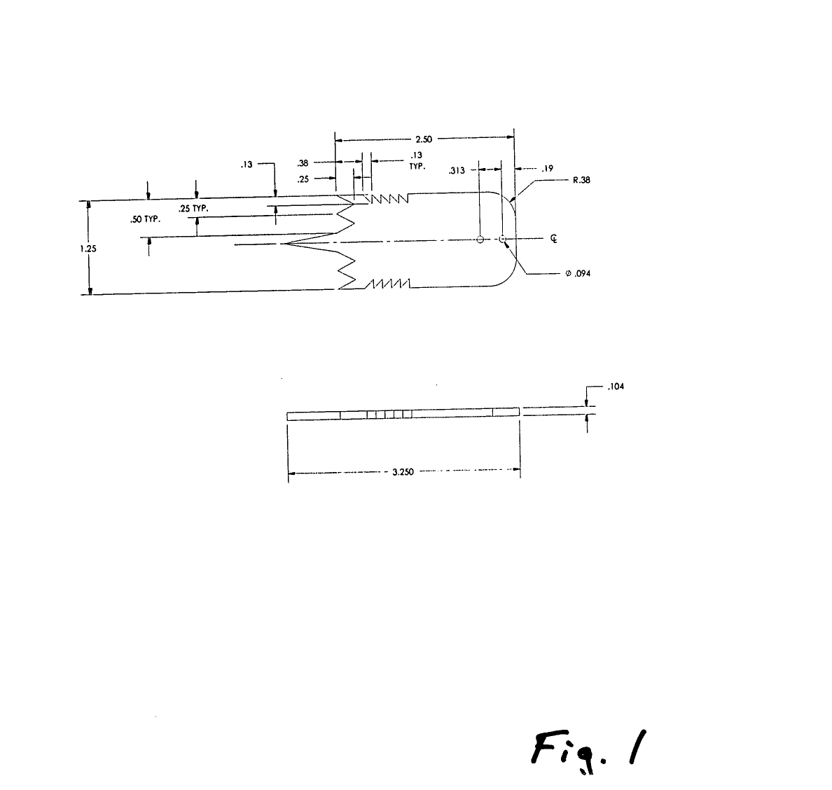

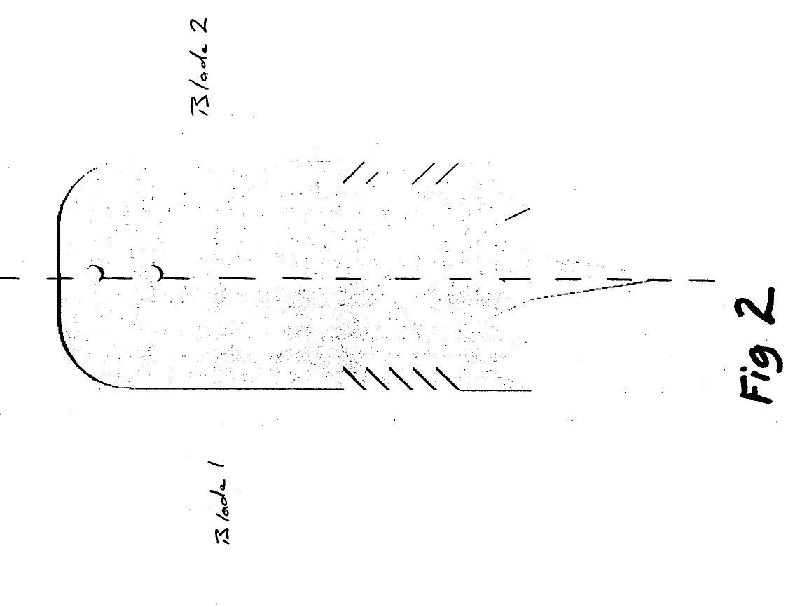

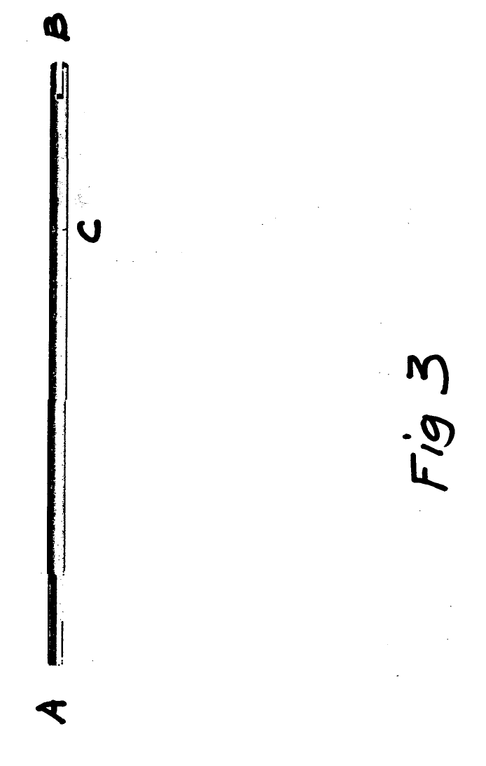

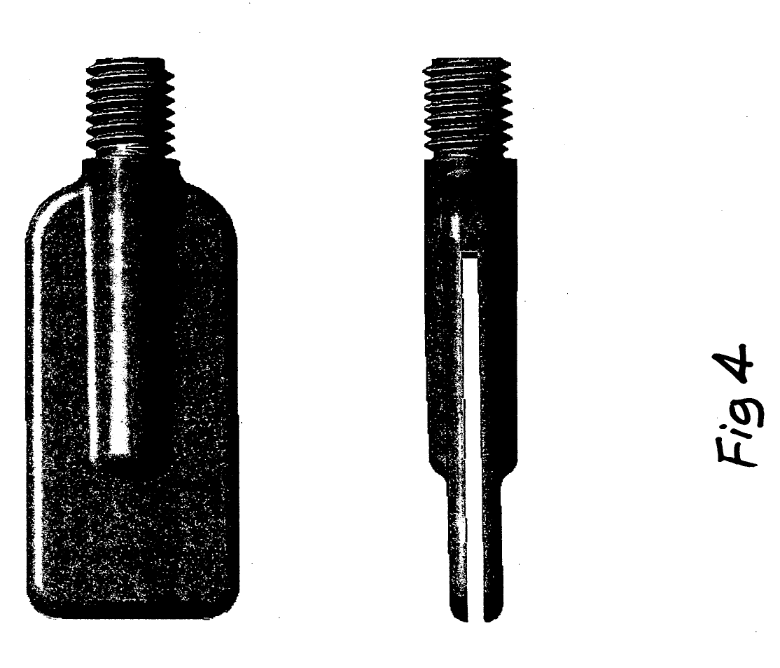

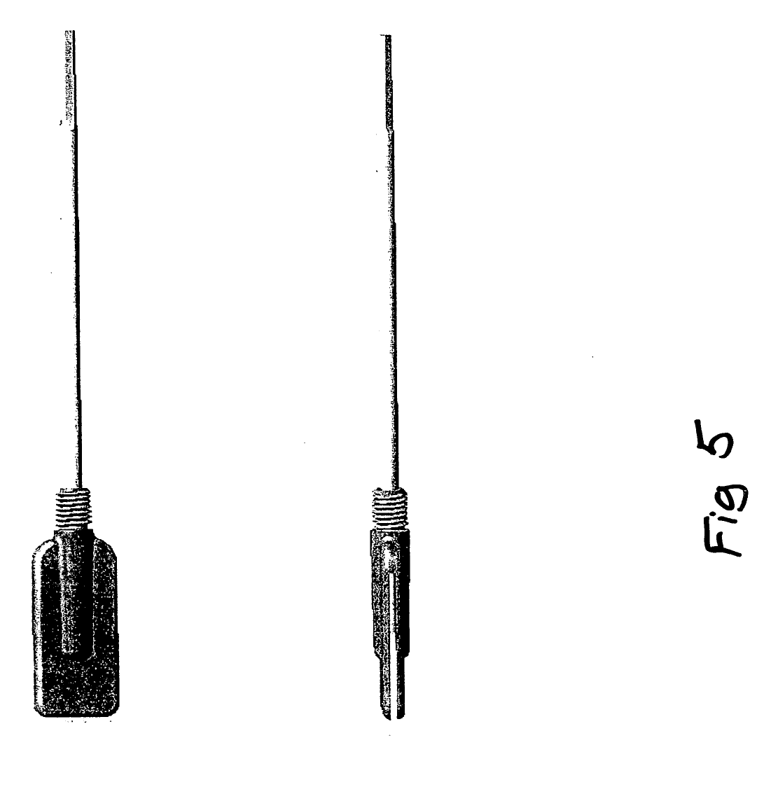

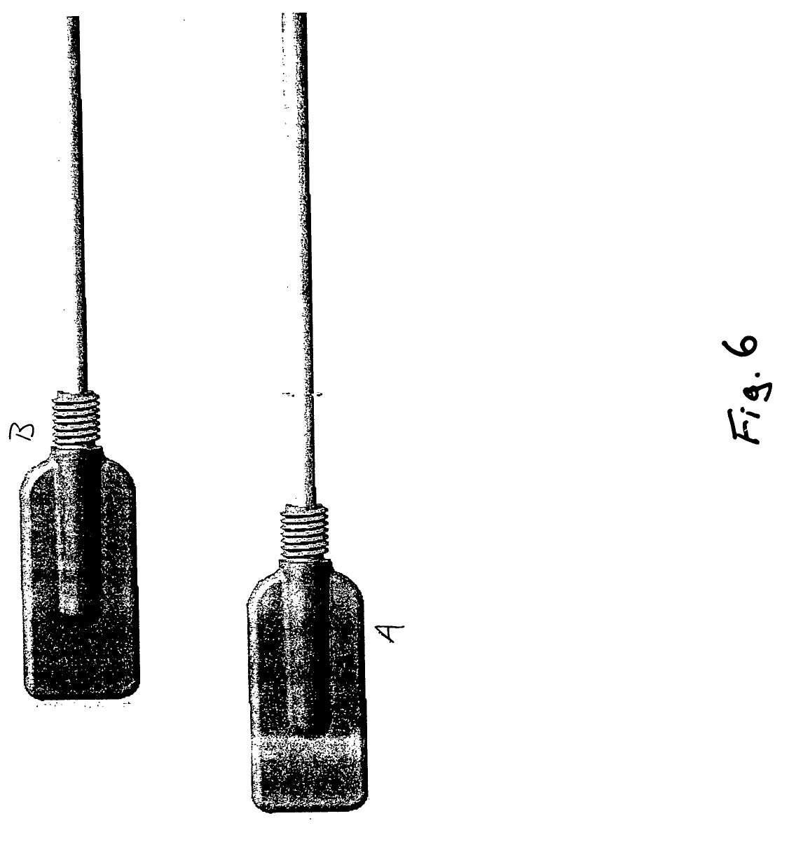

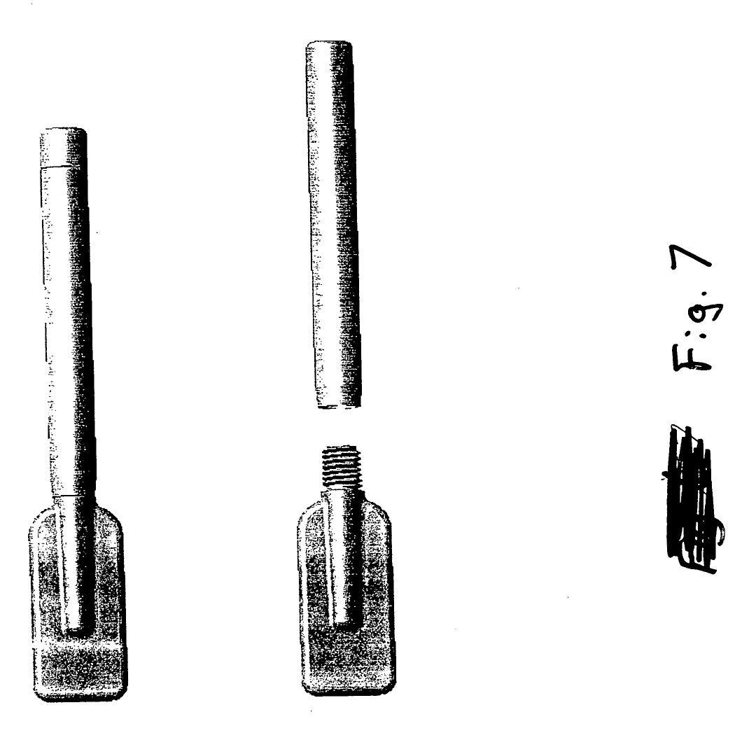

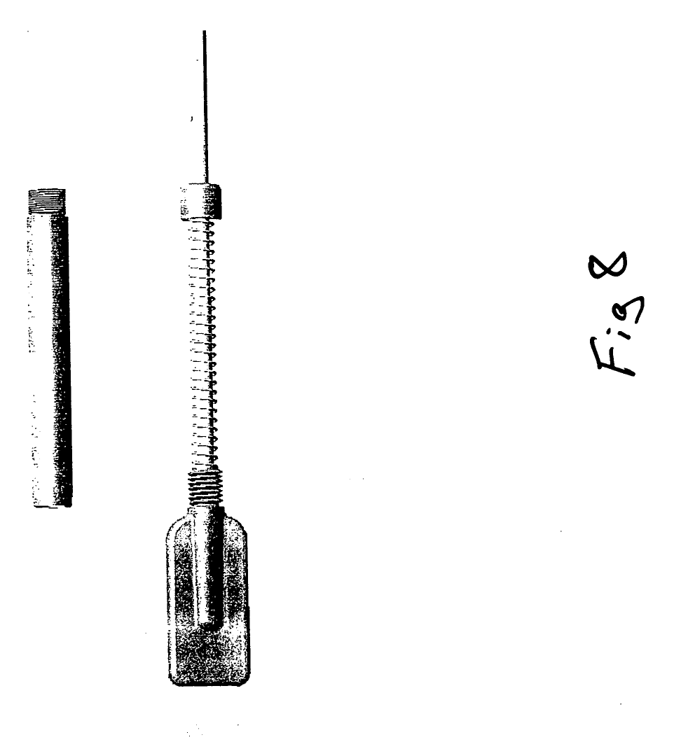

Referring now to the drawings, the preferred embodiment of the Reed Weed Extractor comprises a plurality of components. In their broadest context, such components include:
A cutting head comprised of at least two blades with a plurality of teeth on each blade; (FIG. 1 and FIG. 2)
A shaft attached to the cutting head. One end of such shaft being able to be placed into a standard electric drill chuck and said shaft being of an appropriate length to enable the weed extractor to remove the root crown of the weed and to allow for efficient, comfortable, and safe operation of the extractor (FIG. 3); and
A weed ejector attached to the shaft and designed to allow the ejector, normally located off of the cutting head, to be pushed over the cutting head thereby removing the extracted weed from the cutting head. (FIG. 4). The best mode of the invention is described as follows:
   The cutting head:
      Is made of metal of other rigid material to allow it to enter into hard soil and effectively remove the weed, weed root crown, and weed roots;
      Is non-curved and flat in that its width, that is the distance from left to right, looking at the head as it enters the soil, is substantially greater than its depth, that is, the distance from front to back looking at the head as it enters the soil; (FIG. 1.)
      Has two blades, one located on the head's left and right side. Each blade has cutting teeth of varying size along its entire length and each blade shares a common elongated tip where the blades come together. (FIG. 2.)
      Is attached to a shaft securely in a manner to allow the cutting head to enter into hard soil and effectively remove the weed, weed root crown, and weed roots;
   The shaft:
      Is made of metal of other rigid material to allow it to enter into hard soil and effectively allow the cutting head to rotate and remove the weed, weed root crown, and weed roots;
      Has a first end and a second end. (FIG. 3.)
      Is designed to allow the first end, or non-cutting head end, to be inserted into a standard drill chuck; (FIG. 3, Note A.)
      Is designed to allow the second end, or cutting head end, to be attached to the cutting head; (FIG. 3, Note B.)
      Is notched or otherwise modified to allow the attachment of a retaining clip used to position a weed ejector mechanism; (FIG. 3, Note C.)
   The weed ejector:
      Is made of material rigid enough to allow the ejector to effectively remove extracted weeds yet flexible enough to allow the ejector to be slid over the shaft and cutting head for assembly or disassembly.
      Is designed to fit closely over the cutting head whereby moving the ejector over the cutting head will, of necessity, push weeds attached to the cutting head off of the head. (FIG. 4 and FIG. 5)
      Operates by traveling along a short length of the shaft and over the cutting head. (FIG. 6) The extent of the ejector's forward movement along the shaft is controlled by the ejector butting up against the cutting head. (FIG. 6A.) The extent of the ejector's backward movement along the shaft is controlled by a retaining clip located on the shaft. (FIG. 6B)
      Has a method of connecting to a weed ejector handle. Such handle allowing easy and safe operation of the weed ejector. Such connection may be through use of screw threads on one end of the ejector and the corresponding end of the handle. (FIG. 7) Such handle may be knurled to ensure a secure grip by the operator.
      Returns to its normal position, that is, off of the cutting head, through use of a spring located in the ejector handle. The spring is located and operates between the back of the handle and the retaining ring located on the shaft. (FIG. 8)

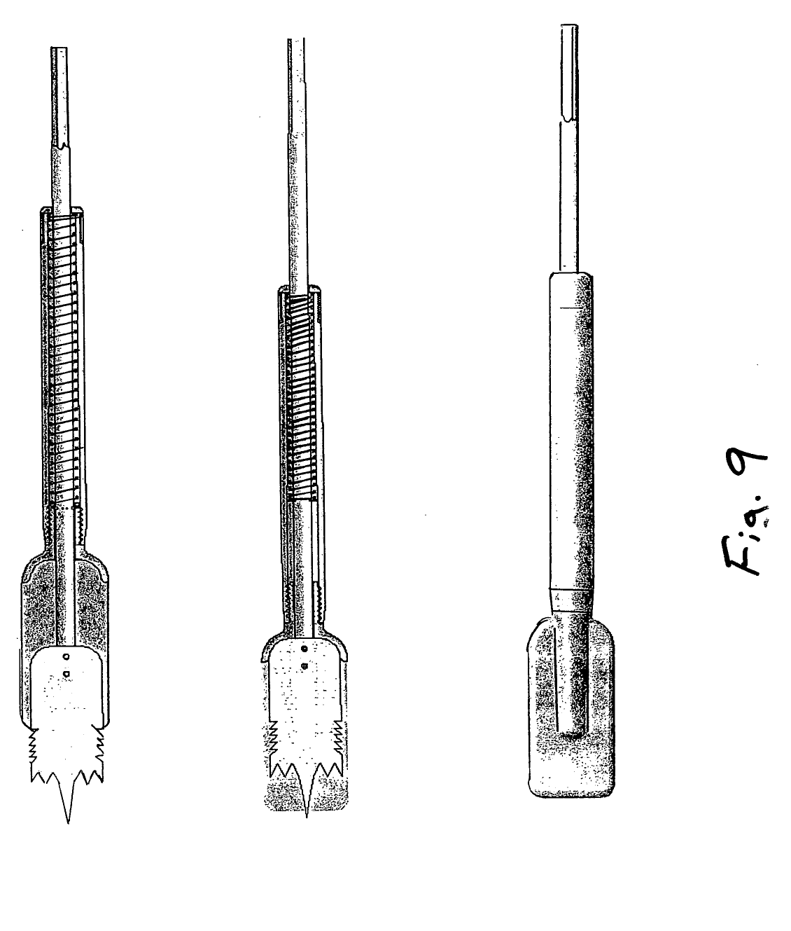

The invention is designed to rotate all the above-described parts during operation. (FIG. 9)

While there is shown and described herein certain specific structures comprising aspects of the invention, it will be manifest to those skilled in the art that various modifications and rearrangements of the parts may be made without departing from the spirit and scope of the underlying invention concept, and that the same is not limited to the particular forms herein shown and described except insofar as indicated by the scope of the claims that follow.

1. a weed extractor powered by a hand-held rotary power tool, said extractor comprising:
a shaft having a first end and a second end;
said shaft's first end designed to fit into a standard portable, hand-held drill;
said shaft's second end attached to a cutting head with at least two blades each blade having a plurality of teeth.

2. the extractor claimed in claim 1 above where the cutting head is flat and non-curved having a width substantially greater than its depth and the cutting head having a right and a left side. (FIG. 1)

3. the extractor claimed in claim 2 above where the cutting head has two blades, one blade located on the right side of the head and the other blade located on the left side of the head. (FIG. 1 and FIG. 2)

4. the extractor claimed in claim 1 or claim 2 above where a weed ejector (FIG. 4.) is attached to said shaft, such weed ejector being designed to slide over the cutting head (FIG. 5 and FIG. 6) with minimal clearance thereby removing extracted weeds from the cutting head.

5. the extractor claimed in claim 4 above where the weed ejector is attached to a handle, said handle being designed to fit around and travel along the shaft. (FIG. 7)

6. the apparatus claimed in claim 5 above where the weed ejector after being slid over the cutting head to remove weeds, is designed to return to its normal operating location, that is, off of the cutting head, by a spring. Said spring being located within the handle. (FIG. 8)
